(19) United States
(12) Patent Application Publication
(10) Pub. No.: US 2008/0092153 A1
(43) Pub. Date: Apr. 17, 2008

(54) System and process for forming a durable image on an optical disk

(75) Inventors: Jathan D. Edwards, Afton, MN (US); Richard R. Ollmann, Stillwater, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/973,559

(22) Filed: Oct. 9, 2007

Related U.S. Application Data
(60) Provisional application No. 60/851,031, filed on Oct. 11, 2006.

(51) Int. Cl. G11B 7/24

(52) U.S. Cl. 720/719

(57) ABSTRACT

A process for durably protecting an image applied to a digital information disk includes providing an optical disk including an image disposed on a surface of the optical disk, and inkjet printing a clear coat composition supplied by an inkjet cartridge over the image.

### CROSS-REFERENCE TO RELATED APPLICATIONS

This Non-Provisional Utility Patent Application claims the benefit of the filing date of U.S. Provisional Patent Application Ser. No. 60/851,031, filed Oct. 11, 2006, entitled “SYSTEM AND PROCESS FOR FORMING A DURABLE IMAGE ON AN OPTICAL DISK,” which is incorporated herein by reference.

### FIELD

Aspects of this application relate to preserving an image on a surface of an information disk, and more particularly, to inkjet printing a clear coating over an image printed on a surface of an information disk to protect and preserve the image.

### BACKGROUND

Information disks, including compact disks (CD), digital video disks (DVD), and business card disks are commonly used to store vast amounts of digital information for subsequent retrieval and use. Information disks can include designs or images printed on a surface of the information disk. For example, businesses that provide product catalogs will offer a CD having the catalog information digitally stored on the CD, and a color image printed on a surface of the CD, such as a graphic from a cover portion of the catalog. The images printed on information disks are limited only by the imagination of the user.

Images printed on information disks are known to have poor durability in the presence of ozone, moisture, high humidity, sunlight, etc. In particular, inkjet printed images often employ a water soluble or water dispersible colorant in a water-based ink. At least some of the colorant in the water-based ink moves, or flocculates, to an upper surface of the image and becomes exposed to environmental conditions. In this manner, colorful inkjet printed images on the surface of the information disk are vulnerable to smearing, smudging, and environmental degradation that has the potential to damage or destroy the printed image.

Improvements to the durability of images printed on information disks would be useful to a wide array of disk users.

### SUMMARY

One aspect provides a process for durably protecting an image applied to a digital information disk. The process includes providing an optical disk including an image disposed on a surface of the optical disk, and inkjet printing a clear coat composition supplied by an inkjet cartridge over the image.

Another aspect provides a system for durably printing an image onto a digital information disk. The system includes an electronically controlled print carriage, at least one ink cartridge movably coupled to the print carriage, and at least one clear coat cartridge movably coupled to the print carriage. The print carriage is coupled to a disk changer that is configured to transfer an information disk from a location exterior the inkjet printer to an imaging location adjacent to the print carriage. In this regard, the electronically controlled print carriage is operable to print an image onto a surface of the information disk with the ink cartridge(s) and sequentially inkjet print a clear coat composition over the image with the clear coat cartridge.

Another aspect provides a system for durably printing an image onto an information disk. The system includes means for transferring the information disk to an imaging location of the system, and an electronically controlled print carriage positioned adjacent to the imaging location and including at least one ink cartridge and at least one clear coat cartridge movably coupled to the print carriage. The electronically controlled print carriage is operable to print an image onto a surface of the information disk with the at least one ink cartridge and sequentially inkjet print a clear coat composition over the image with the clear coat cartridge.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a disk duplication system according to one embodiment;

FIG. 2A is a top view of a backside of an information disk according to one embodiment;

FIG. 2B is a side view of the information disk shown in FIG. 2A;

FIG. 3 is a perspective, simplified view of the disk duplication system of FIG. 1 with a housing portion removed to illustrate a print carriage and multiple inkjet cartridges according to one embodiment;

FIG. 4A is a perspective view of a cartridge suitable for containing a protective ink according to one embodiment;

FIG. 4B is a cross-sectional view of the cartridge illustrated in FIG. 4A; and

FIG. 5 is a perspective view of an information disk imaging system according to one embodiment.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of the embodiments can be positioned in a number of different orientations, the directional terminology is used for purposes of illustration and is in no way limiting. It is to be understood that other embodiments may be utilized and structural or logical changes may be made without departing from the scope of the disclosure. The following detailed description, therefore, is not to be taken in a limiting sense, and the scope of the present invention is defined by the appended claims.

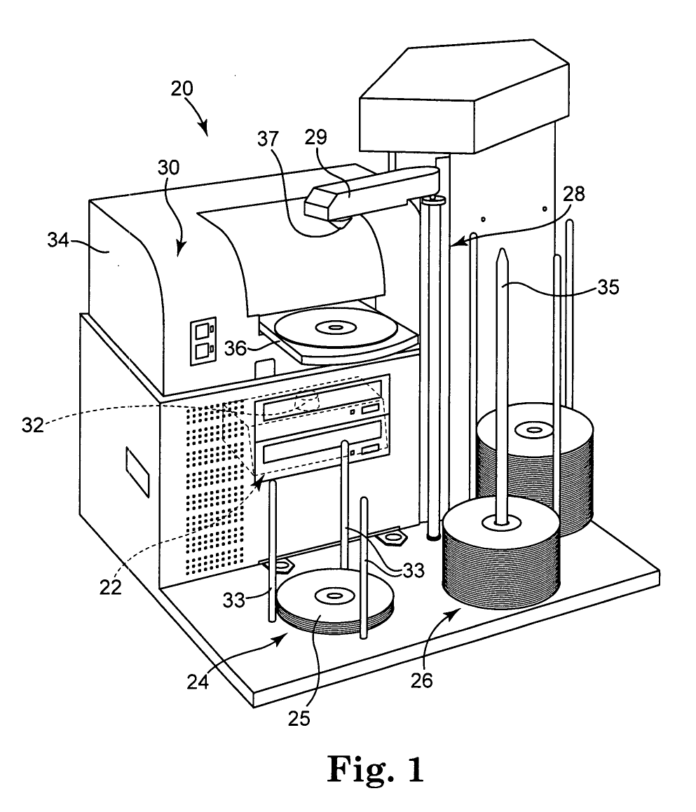

FIG. 1 is a perspective view of a disk duplication system 20 according to one embodiment. The disk duplication system 20 includes a digital information subassembly 22, a disk input spindle 24 configured to queue one or more virgin information disks 25 for duplication, a disk output spindle 26 adjacent to the disk input spindle 24, a tower 28 including a movable arm 29 that is configured to move the disks 25 in a duplication process, an image duplication subassembly 30, and a disk changer 36 coupled between the digital information subassembly 22 and the image duplication subassembly 30.

The disk duplication system 20 is provided as a stand-alone powered assembly in one embodiment, although in other embodiments the system 20 is provided as a component in a computer-based duplication network. In this regard, the system 20 can be electrically coupled to various peripheral electronic components, such as monitors, graphical user interfaces, personal computers, and the like.

In one embodiment, the digital information subassembly 22 includes a write head 32 configured to write digital information to the disks 25 during duplication. In general, the write head 32 is electrically coupled to a memory device (not shown) of the digital information subassembly 22. The write head 32 writes information to the disks 25 being duplicated and can include any suitable optical head, including read/write heads and other such optical heads.

The disk input spindle 24 and the disk output spindle 26 can include any suitable device that stations the disks entering and exiting the digital information subassembly 22 and the image duplication subassembly 30. In one embodiment, the disk input spindle 24 is a stanchion-styled device that is configured to maintain the disks within a perimeter of three, for example, vertical riser posts 33, although other suitable stationing devices are also acceptable such as the skewer-styled device 35 illustrated as the exemplary disk output spindle 26.

The tower 28 is an electromechanical device including a servomotor (not shown) and a controller (not shown) that are configured to move the movable arm 29 to facilitate staging of the disks 25 as they flow through the duplication system 20. In one embodiment, the movable arm 29 is movable in at least two axes: up/down for moving disks 25 away from the spindles 24, 26, and in an arc that traverses a picker 37 of the movable arm 29 between the spindles 24, 26 and the subassemblies 22, 30. Thus, the movable arm 29 is operable through a range of motions having multiple degrees of freedom.

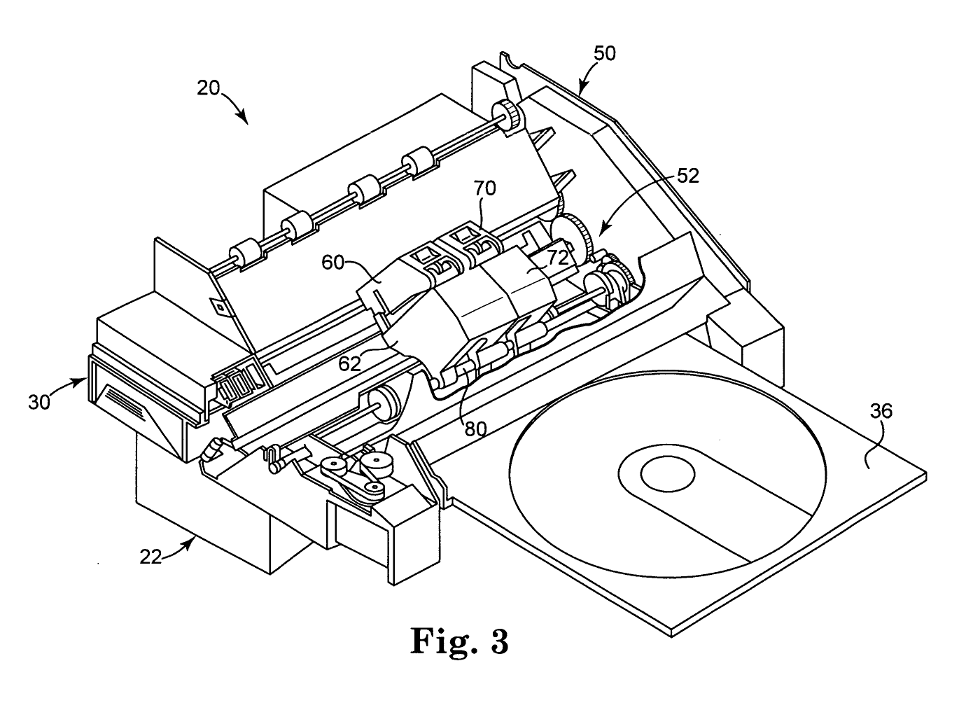

In one embodiment, the image duplication subassembly 30 includes an inkjet printer (See FIG. 3) enclosed by a housing 34 of the disk duplication system 20. In this regard, the inkjet printer is generally disposed adjacent to the digital information subassembly 22, both of which are covered by the housing 34.

The disk changer 36 is operable by the system 20 to move virgin disks 25 into the digital information subassembly 22 and into the image duplication subassembly 30 during a duplication process. For example, the movable arm 29 moves vertically along the tower 28 (relative to the orientation of FIG. 1) in transferring a virgin disk 25 from the input spindle 24 to the disk changer 36. The disk changer 36 inputs the disk 25 into the digital information subassembly 22 and the image duplication subassembly 30, and the disk 25 is written with digital information and printed with an image, respectively. After duplication of the disk 25 is complete, the disk changer 36 exits the housing 34, and the movable arm 29 transfers a duplicated disk to the output spindle 26.

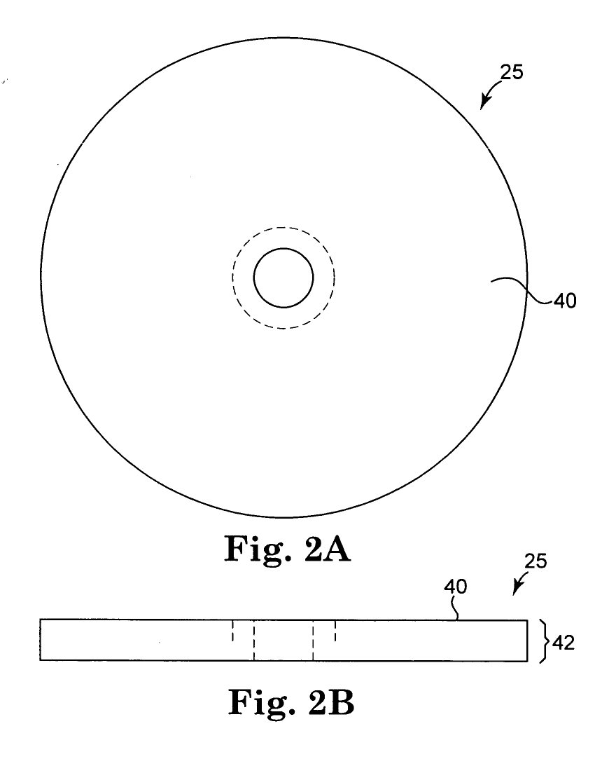

FIG. 2A is a top view of a backside 40 of the disk 25 according to one embodiment. In general terms, the disk 25 is a storage medium from which data is read and to which data can be written. The disk 25 can include an optical disk such as a CD-ROM, a write once read many (WORM) disk, an erasable optical disk, or any other suitable optical disk. That is to say, disks 25 suitable for image duplication are available in various formats.

In one embodiment, the disk 25 is a CD disk including a strata 42 that culminates in the backside 40. With this in mind, in one embodiment the strata 42 includes a 1.2 mm substrate, a dye layer including a recording layer, a reflector layer, and an inkjet receptor layer that is exposed on the backside 40.

In another embodiment, the disk 25 is a DVD disk and the strata 42 includes two substrates bonded together such that a data surface is encapsulated between the two substrates, and has a receptor layer that is exposed on the backside 40.

Generally, then, the backside 40 includes some form of a receptor layer in any one of the many formats of the disk 25. The backside 40 is preferably porous and suited for receiving an ink printed image. In this regard, in one embodiment the backside 40 defines a microporous surface configured to absorb inkjet printed inks.

FIG. 3 is a simplified, perspective view of one embodiment of a portion of the duplication system 20 having the housing 34 (FIG. 1) removed for illustrative purposes. In this regard, the disk changer 36 is illustrated as coupled between the digital information subassembly 22 and the image duplication subassembly 30 and is configured to transfer the information disk 25 into the housing 34 in register with a printing system of the image duplication subassembly 30. For example, in one embodiment the image duplication subassembly 30 includes an inkjet printer 50 configured to inkjet print a colored image and a clear coat protective coating composition onto the “in-register” disk 25 (FIG. 2A).

In one embodiment, the inkjet printer 50 includes an electronically controlled carriage 52 that communicates with the disk changer 36. In one embodiment, the print carriage 52 includes a first discharge head 60 coupled to an ink cartridge 62, a second discharge head 70 coupled to a protective ink cartridge (PIC) 72, and a shaft 80 along which the discharge heads 60, 70 and the ink cartridge 62 and the PIC 72 translate along. In general, the discharge heads 60, 70 are provided with energy generating means configured to discharge colored ink from the ink cartridge 62, and to discharge protective ink from the PIC 72. In this regard, the discharge heads 60, 70 can include thermal energy generating means, piezoelectric energy generating means, or suitable energy generating means configured to jet droplets of printable liquid from the cartridge 62 and the PIC 72.

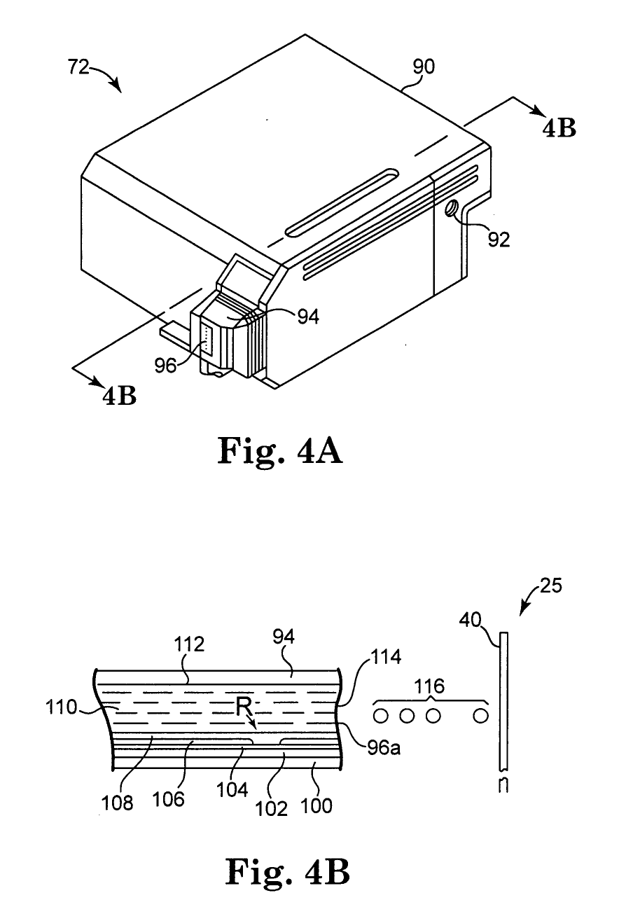

FIG. 4A is a perspective view of the PIC 72 according to one embodiment. The PIC 72 includes a housing 90 that defines a hub 92 and a head 94. The hub 92 is configured to receive the shaft 80 (FIG. 3) of the print carriage 52. The head 94 is provided at one end of the housing 90 and includes multiple orifices 96 through which protective ink is jetted during an inkjet process.

FIG. 4B is a cross-sectional view of the PIC 72 with the cross-section taken through the head 94. In one embodiment, the head 94 is a thin film head, although other suitable heads are also acceptable. In this regard, in one embodiment the head 94 includes a substrate 100, a heat generating layer 102, a heat resistor layer 104, electrodes 106, a protective film 108 adjacent to a reservoir 110, and a passage 112 in fluid communication with the reservoir 110. In one embodiment, the substrate 100 is formed of alumina or another suitable substance, the heat resistor layer 104 is formed of nichrome or another suitable substance, the electrodes 106 are aluminum electrodes or other suitable electrode material, and the protective film 108 is silicon oxide or another suitable substance.

When electrical signals are supplied to the electrodes 104, the region R is heated, and protective ink in the reservoir 110 in contact with the region R generates bubbles, the pressure of which produces a meniscus 114 along an orifice 96A. In this manner, protective ink from the reservoir 110 is discharged as droplets 116 and is delivered to, for example, the backside 40 of the information disk 25.

In this specification, protective ink is defined to include an ink formed of a colorless material capable of acting as a protective layer when dissolved or dispersed in a vehicle and delivered to an image on information disk. Protective inks include latex protective inks, resin protective inks, and curable protective inks. A latex protective ink includes a liquid vehicle having a substantially colorless latex particle dispersed within. A resin protective ink includes a liquid having a substantially colorless resin dissolved within. A curable protective ink includes a liquid vehicle having a substantially colorless curable material dissolved within.

A vehicle is any inkjettable liquid or fluid and can include water, alcohol, glycol, and/or glycerin.

Latex includes an emulsion of rubber or plastic globules in water, for example as used in paints, adhesives, inkjet materials, and synthetic rubber products.

A resin includes any of numerous physical similar polymerized synthetics or chemically modified natural resins including thermoplastic materials such as polyvinyl, polystyrene, and polyethylene, and thermosetting materials such as polyesters, epoxies, and silicones that are used with fillers, stabilizers, pigments, and/or other components to form plastics.

A curable material includes a material made of one or more monomer unit and a system capable of initiating a reaction which organizes the monomer units into organized repeating units. In this regard, the reaction can be initiated by either a photochemical or a thermo-initiated reaction.

Suitable latex containing protective inks include copolymers of latex prepared to have a latex particle size ranging from about 200 nanometers to 300 nanometers. In general, suitable latex containing protective inks are similar to and include those provided in Example 1 and Table 2 of Int'l Pub. No. WO2004/089639.

One suitable latex copolymer protective ink includes a copolymer including about 40 weight percent butyl methacrylate (BMA), about 49 weight percent 2-ethylhexyl methacylate (EHMA), about 10 weight percent methacrylolyoxy ethyl succinate (MES), and about 1 weight percent ethylene glycol dimethacrylate (EGDMA). Another suitable latex copolymer includes about 20 weight percent BMA, about 69 weight percent hexyl methacrylate (HMA), about 10 weight percent MES, and about 1 weight percent EGDMA. Other suitable latex copolymers include an HMA weight percent of between about 70 and 90%, and a balance of MES with EGDMA at about 1 percent. In another embodiment, a suitable latex copolymer protective ink includes about 20 weight percent styrene, about 73 weight percent HMA, about 6 weight percent methacrylic acid MMA, and about 1 weight percent EGDMA. It is to be understood that other suitable combinations of the above-identified compounds are also acceptable.

Suitable resin protective inks include a resin dissolved in an ink-jettable vehicle that is configured to be deposited and form a protective layer upon drying. In general, suitable resin protective inks are similar to and include anionic polymer overcoat compositions as provided in Example 4, Table 4 of U.S. Patent Appl. Pub. No. US2005/0225618A1.

One suitable resin protective ink includes a polymer overcoat composition having polymeric particulates dispersed in a liquid vehicle, such as, for example, latex particulates dispersed in a liquid vehicle and/or a latex dispersion of latex particles in a liquid. The polymeric particulates are selected to have a particle size ranging from about 20 nm to 500 nm, preferably the particle size ranges from about 100 nm to about 300 nm. Preferably, the resin protective ink is colorless or substantially colorless and is suited for overprinting of color images printed onto disks 25.

Latex-based dispersions include polymeric particulates of polymerized monomers where the polymeric particulates are selected to have a molecular weight ranging from about 10,000 Mw to 2,000,000 Mw, preferably the molecular weight ranges from about 40,000 Mw to about 100,000 Mw. Such latex-based polymeric particulates can be characterized as having a glass transition temperature ranging from about 25° C. to about 100° C. Exemplary latexes are available from Rohm and Haas, Philadelphia, Pa., and are identified as NM3266-B and NM3270-B.

Suitable curable protective inks include inks having a sensitizer, an initiator, and a polymerizable component in a jettable vehicle. In general, suitable curable protective inks are similar to and include those provided in Example 1, Table 1 of U.S. Pat. No. 5,312,654.

One suitable curable protective ink is a photopolymerizable ink composition including a photopolymerizable compound at about 90% added to a photopolymerization initiator at about 7%, and including a silane coupling agent added at about 3%. Suitable photopolymerizable compounds include diethylene glycol dimethacrylate, dipropylene glycol dimethacrylate, polyethylene glycol dimethacrylate, glycerine dimethacrylate, trimethylolpropane trimethacrylate, and suitable reaction products of ethoxymethylacrylamide and dipropylene glycol. One suitable photopolymerization initiator is identified as IR-651 available from Ciba Geigy Company, Tarrytown, N.Y. One suitable silane coupling agent is identified as SZ-6030 available from Toray Silicone Company, Tokyo, Japan.

With additional reference to FIG. 2A and FIG. 3, the disk duplication system 20 is configured to write information digitally to the disk 25 with the digital information subassembly 22, and to print a durable image onto the backside 40 with the image duplication subassembly 30. In particular, a disk 25 is placed in the disk changer 36 by the movable arm 29 (FIG. 1). A color image is printed onto the backside 40 of the disk 25 by the color ink cartridge 62 in a first pass of the carriage 52 across the disk 25. Subsequently, a second pass of the carriage 52 across the disk 25 inkjet prints a protective ink coating from the PIC 72 over the image printed onto the backside 40. In one embodiment, the time required for the carriage 52 to traverse and print a color image onto the backside 40 is selectively controlled such that the color ink cures or otherwise dries sufficiently in time prior to the second pass of the clear protective coating deposited by the PIC 72. In this regard, one embodiment of the system 20 provides for timing an expiration of a delay period prior to inkjet printing the clear coat composition via PIC 72 over the image, where the delay period is selected to enable curing of the ink composition.

In one embodiment, an image is printed by the color ink cartridge 62 as the carriage 52 traverses past the disk 25 and simultaneously thereafter a clear protective coating is inkjet printed from the PIC 72 over the image deposited by the ink cartridge 62. That is to say, in one embodiment the carriage speed is selected to enable printing and drying of a color inkjet image onto the porous backside 40 immediately ahead of the protective coating being deposited by the PIC 72.

In one embodiment, the disk 25 includes an image appliqué adhered to the backside 40, and the inkjet printer 50 is configured to inkjet print only the clear protective ink from the PIC 72 over the applique on the disk 25. In this regard, in one embodiment the protective ink delivered by the PIC 72 forms a glossy coating over the image printed on the disk 25. In another embodiment, the backside 40 is microporous surface, and a printing of a color image onto the microporous surface 40 results in a matte finished image. Subsequent printing of a clear protective ink from the PIC 72 over the matte image results in a glossy finished surface on the disk 25.

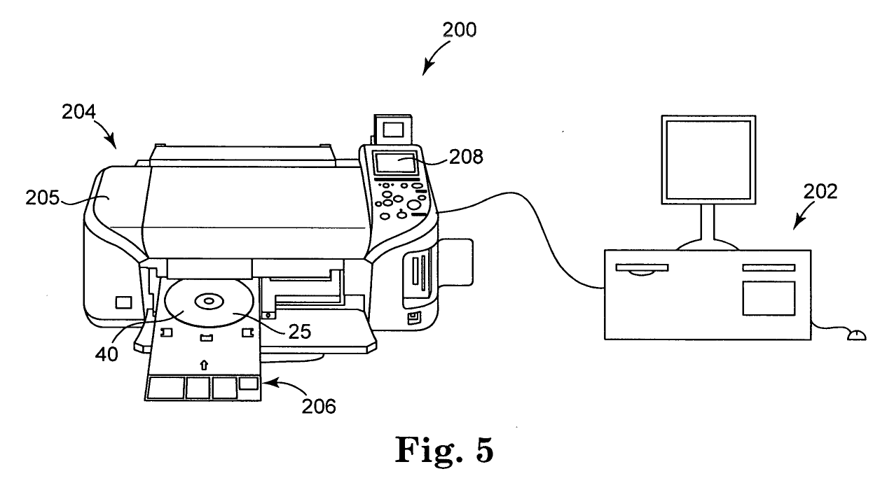

FIG. 5 is a perspective view of an information disk imaging system 200 according to another embodiment. The system 200 includes a computer 202 and an inkjet printer 204 coupled to the computer 202. In one embodiment, the inkjet printer 204 includes a housing 205 that encloses an electronically controlled print carriage (not visible), a disk changer 206 that is configured to transfer an information disk 25 into the housing, and a user interface 208. In general terms, the electronically controlled print carriage that is not visible in FIG. 5 is substantially similar to the print carriage 52 of the inkjet printer 50 illustrated in FIG. 3.

In one embodiment, a user of the system 200 inputs printing preferences into the computer 202 that are electronically communicated to the inkjet printer 204. In this regard, the user is able to select preferences related to image orientation, image size, image surface finish including glossy or matte finishes, and other imaging preferences including color and font size to name a few. In another embodiment, the user interface 208 of the inkjet printer 204 is configured to provide a gloss on demand option that is input by a user prior to printing an image on to the disk 25. In this regard, printing an image on the porous backside 40 results in the disk 25 having a matte-finished image. However, in one embodiment the computer 202 or the user interface 208 is configured to provide a gloss on demand option whereby the colorless protective inkjet printed from the PIC 72 (FIG. 3) forms a glossy overcoat finish on the backside 40 of the disk 25. In this manner, a durable and glossy finish is provided over the image that resists degradation of the image from humidity, moisture, smearing, degradation due to ozone, and degradation due to other environmental factors.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of a system and a process for durably protecting an image applied to a digital information disk as discussed herein. Therefore, it is intended that this invention be limited only by the claims and the equivalents thereof.

What is claimed is:

1. A process for durably protecting an image applied to a digital information disk, the process comprising:
providing an optical disk including an image disposed on a surface of the optical disk; and
inkjet printing a clear coat composition supplied by an inkjet cartridge over the image.

2. The process of claim 1, wherein providing an optical disk comprises inkjet printing an image with an ink composition supplied by a first inkjet cartridge onto a surface of the optical disk.

3. The process of claim 2, further comprising:
timing an expiration of a delay period prior to inkjet printing the clear coat composition over the image, the delay period selected to enable curing of the ink composition.

4. The process of claim 1, wherein providing an optical disk comprises providing an optical disk including an image applique disposed on a surface of the optical disk.

5. The process of claim 1, wherein the clear coat composition comprises a latex containing protective ink.

6. The process of claim 1, wherein the clear coat composition comprises a resin protective ink.

7. The process of claim 1, wherein the clear coat composition comprises a liquid vehicle including a substantially colorless ink dissolved in the vehicle, the colorless ink including a photochemically curable monomer system.

8. The process of claim 1, wherein the clear coat composition comprises a liquid vehicle including a substantially colorless ink dissolved in the vehicle, the colorless ink including a thermally curable monomer system.

9. The process of claim 1, wherein inkjet printing a clear coat composition comprises:
providing an inkjet printer electrically coupled to a user interface; and
selecting a user preference for a level of gloss of the inkjet printed clear coat composition by inputting the preference into the user interface.

10. A system for durably printing an image onto a digital information disk, the system comprising:
an electronically controlled print carriage coupled to a disk changer that is configured to transfer an information disk to an imaging location adjacent to the print carriage;
at least one ink cartridge movably coupled to the print carriage; and
at least one clear coat cartridge movably coupled to the print carriage;
wherein the electronically controlled print carriage is operable to print an image onto a surface of the information disk with the at least one ink cartridge and sequentially inkjet print a clear coat composition over the image with the at least one clear coat cartridge.

11. The system of claim 10, further comprising:
an image duplication sub-assembly housing an inkjet printer;
wherein the disk changer is configured to transfer the information disk into the image duplication sub-assembly in register with the print carriage.

12. The system of claim 11, wherein the image duplication sub-assembly is a component of a disk duplication system comprising:
an information disk input spindle configured to queue one or more virgin information disks for duplication;
an information disk output spindle adjacent to the information disk input spindle and configured to receive one or more duplicated information disks;
a digital information sub-assembly including a write head configured to write digital information to the information disks during duplication; and
a tower including a movable arm, the movable arm configured to move the virgin information disks from the input spindle to the image duplication sub-assembly and the digital information sub-assembly.

13. The system of claim 10, wherein the clear coat composition comprises a latex containing protective ink.

14. The system of claim 10, wherein the clear coat composition comprises a resin protective ink.

15. The system of claim 10, wherein the clear coat composition comprises a liquid vehicle including a substantially colorless ink dissolved in the vehicle, the colorless ink including a photochemically curable monomer system.

16. The system of claim 10, wherein the clear coat composition comprises a liquid vehicle including a substantially colorless ink dissolved in the vehicle, the colorless ink including a thermally curable monomer system.

17. A system for durably printing an image onto an information disk, the system comprising:
means for transferring the information disk to an imaging location of the system; and
an electronically controlled print carriage positioned adjacent to the imaging location and including at least one ink cartridge and at least one clear coat cartridge movably coupled to the print carriage;
wherein the electronically controlled print carriage is operable to print an image onto a surface of the information disk with the at least one ink cartridge and sequentially inkjet print a clear coat composition over the image with the clear coat cartridge.

18. The system of claim 17, wherein the means for transferring the information disk to an imaging location of the system comprises a movable arm configured to transport the information disk between an input spindle maintaining at least one information disk to an image duplication sub-assembly that includes the print carriage.

19. The system of claim 17, wherein the clear coat composition comprises a liquid vehicle including a substantially colorless ink dissolved in the vehicle.

20. The system of claim 19, wherein the substantially colorless ink comprises one of a photochemically curable monomer system and a thermally curable monomer system.
